(19) United States
(12) Patent Application Publication
(10) Pub. No.: US 2025/0251541 A1
(43) Pub. Date: Aug. 7, 2025

(54) SHAPED PART AND METHOD FOR PRODUCING A SHAPED PART

(71) Applicant: Novem Car Interior Design GmbH, Vorbach (DE)

(72) Inventors: Alexander MARTIN, Neuhaus an der Pegnitz (DE); Philipp WEIH, Haag (DE)

(21) Appl. No.: 18/841,159

(22) PCT Filed: Feb. 22, 2023
(86) PCT No.: PCT/EP2023/054473

§ 371 Date: Apr. 9, 2025

(30) Foreign Application Priority Data
Feb. 23, 2022 (DE) 102022104308.8

(51) Int. Cl. F21V 8/00; B29D 11/00; B29K 75/00; B60Q 3/62; B60R 13/02

(52) U.S. Cl. CPC G02B 6/0036; B29D 11/00721; G02B 6/0065; B29K 2075/00; B60Q 3/62; B60R 13/02

(57) ABSTRACT

The invention relates to a shaped part (10) comprising a decorative layer (11); a micro-perforation (16) formed by a plurality of through holes (15); an illumination and/or display unit (17), wherein light emanating from the illumination and/or display unit (17) can be guided through the micro-perforation (16) of the decorative layer (11) to the visible side of the shaped part (10); and a transparent or translucent light guide layer (18), wherein the light guide layer (18) is arranged on the front side (12) or on the rear side (13) of the decorative layer (11), wherein the light guide layer (18) extends at least partially, in particular completely, into the holes (15) of the micro-perforation (16), so that the holes (15) are at least partially, in particular completely, filled with the material of the light guide layer (18).

The invention further relates to a method for producing a shaped part (10).

The invention relates to a shaped part, in particular a decorative part and/or panel part designed as a shaped part for a vehicle interior, and to a method for producing a shaped part, in particular this shaped part.

Numerous decorative and panel parts are installed in the vehicle interior, for example door panels, console panels, and instrument panels. The decorative and panel parts also include control buttons or the covers of control buttons.

The integration of display and illumination functions is often desired for such shaped parts. The integration of display and illumination functions behind a flat, uninterrupted decorative layer leads to reduced luminance, edge sharpness and increased color location deviation. Therefore, such decorative layers are perforated to create a way to direct light from the rear side of the decorative layer to the front side of the decorative layer.

However, the perforation creates a so-called “tunnel effect” (or a “channel”), which leads to increased viewing angle dependence. The display/illumination functions are therefore only visible within a small angle range, in particular around 90°, which is considered a disadvantage. Decorative and panel parts are therefore only suitable to a limited extent for the integration of display and illumination functions.

The present invention is based on the object of specifying a new shaped part, in particular a new shaped part which at least largely avoids the aforementioned disadvantages. It is also an object of the invention to provide a new method for producing a shaped part, in particular the shaped part according to the invention.

This object is achieved in terms of the shaped part by the features of claim 1 and in terms of the method by the features of claim 8. Advantageous embodiments and further developments are provided in each of the dependent claims.

The shaped part according to the invention comprises a decorative layer having a front side designed as a visible side, a rear side opposite the front side, and a micro-perforation formed by a plurality of through holes, wherein the holes each extend in a straight line along their corresponding longitudinal axis between the rear side and the front side of the decorative layer. Furthermore, the shaped part comprises an illumination and/or display unit, wherein light emanating from the illumination and/or display unit can be guided through the micro-perforation of the decorative layer to the visible side of the shaped part.

The shaped part further comprises a transparent or translucent light guide layer, wherein the light guide layer is arranged on the front side or on the rear side of the decorative layer, wherein the light guide layer extends at least partially, in particular completely, into the holes of the micro-perforation, so that the holes are at least partially, in particular completely, filled with the material of the light guide layer.

The luminance and edge sharpness are increased by the perforation of the decorative layer compared to the illumination of a decorative layer without perforation. Furthermore, the color location shift is reduced by the perforation.

The advantages of the invention lie in particular in the fact that the viewing angle dependence is significantly reduced by filling the perforation with a transparent or translucent material. The so-called tunnel effect is thus reduced by the light guide layer that penetrates the holes.

Micro-perforation is understood to mean the presence of a plurality of through holes (or apertures) in the decorative layer. The material of the decorative layer is therefore removed in the region of the holes. The longitudinal axis of each hole through which visible light is guided from the rear side to the front side of the decorative layer can be oriented parallel and/or congruent or obliquely to a surface normal of the front side of the decorative layer at the exit point of the corresponding hole. Furthermore, the holes can in particular run parallel to one another.

The cross section of the holes perpendicular to their corresponding longitudinal axis can be, for example, round or elliptical or angular. Particularly preferably, the cross sections of the holes are round. The diameters of the holes are in particular in the range from 40 to 160 μm, preferably 60 to 140 μm, for example 100 μm.

The shape and/or dimensions of the cross section of the holes may be uniform or constant along their corresponding longitudinal axis. However, it is also possible for the shape and/or dimensions of the cross section of the holes to change along their longitudinal axis; in particular, the cross-sectional dimensions can decrease from the rear side of the decorative layer to the front side of the decorative layer. For example, with a round cross section, the holes can be shaped like a truncated cone, with the cross section decreasing towards the front side.

If the light guide layer is arranged on the rear side of the decorative layer, the shaped part has an open-pored surface, and if the light guide layer is arranged on the front side of the decorative layer, the shaped part has a high-gloss surface.

A particularly preferred embodiment of the invention provides that the light guide layer comprises PUR or is formed from PUR. Alternatively, the light guide layer can comprise or be formed from a clear plastics material, in particular PMMA or PC.

Preferably, the shaped part comprises a carrier, wherein the carrier is arranged on the rear side of the light guide layer or on the rear side of the decorative layer. The carrier can be a carrier layer, wherein the carrier layer is arranged completely or partially on the rear side of the decorative layer or the rear side of the light guide layer. The carrier may also comprise or be formed from one or more fastening elements, such as hooks or clips.

The carrier can consist of or comprise a plastics material, for example polyurethane (PUR) and/or polycarbonate (PC) and/or polypropylene (PP). Furthermore, it can be provided that the carrier is injection-molded onto the rear side of the decorative layer. The carrier can also be cast onto the rear side of the decorative layer. Alternatively, the carrier can be bonded or pressed onto the rear side of the decorative layer, in particular by means of one or more adhesive plies. The carrier can also be welded to the rear side of the decorative layer. The carrier may further comprise one or more recesses, in particular for accommodating the illumination and/or display unit.

An embodiment variant of the invention provides that the decorative layer is or comprises a wood veneer. However, the decorative layer can also comprise or consist of metal, for example aluminum, and/or carbon and/or stone and/or textile materials and/or fabric and/or plastics material, for example a plastic film, for example an IMD film and/or IML film and/or FIM film. The decorative layer can also consist not only of one decorative ply but also of two or more plies. The decorative layers can each be made of one of the aforementioned materials.

According to a development of the invention, a lamination, for example comprising fleece and adhesive, is arranged on the rear side of the decorative layer, in particular between the rear side of the decorative layer and the carrier or between the rear side of the decorative layer and the light guide layer.

One embodiment variant of the invention provides that the light guide layer is arranged on the rear side of the decorative layer, wherein the light guide layer extends completely into the holes of the micro-perforation, wherein the holes are overfilled with the material of the light guide layer in such a way that an, in particular thin, overhang layer made of the material of the light guide layer is formed on the front side of the decorative layer, at least in the region of the micro-perforation.

The illumination and/or display unit may be a display, for example an LCD or an LED display or a PLED display, or a circuit board on which micro-LEDs are arranged and/or attached and/or electrically contacted. The illumination and/or display unit may also be a static display, for example showing a symbol. The illumination and/or display unit may also be an illumination device that creates, for example, ambient lighting.

The light guide layer can have an embossing on its front side, in particular to achieve haptic effects when touched.

The method according to the invention for producing a shaped part, in particular a shaped part according to the invention, comprises the steps of:
a) providing a decorative material for forming a decorative layer of the shaped part, wherein the decorative layer has a front side designed as a visible side and a rear side opposite the front side,
b) introducing a plurality of through holes into the decorative layer to form a micro-perforation in such a way that the holes each extend in a straight line along their corresponding longitudinal axis between the rear side and front side of the decorative layer,
c) applying, in particular by molding or casting, a transparent or translucent, highly conductive material to the front side or to the rear side of the decorative layer to form a light guide layer, wherein the material for forming the light guide layer penetrates at least partially, in particular completely, into the holes of the micro-perforation, so that the holes are at least partially, in particular completely, filled with the material of the light guide layer,
d) arranging at least one illumination and/or display unit on or in the shaped part, wherein light emanating from the illumination and/or display unit can be guided through the micro-perforation of the decorative layer to the visible side of the shaped part.

One advantage of the method is that different “surfaces” of the shaped part, for example the decorative layer itself or the light guide layer, can be produced in the same tool.

Particularly preferably, the material for forming the light guide layer comprises PUR or is formed from PUR. Alternatively, the material for forming the light guide layer can comprise or be formed from a clear plastics material, in particular PMMA or PC.

The holes can be introduced into the decorative material to form the micro-perforation by lasering or fine cutting (also fine punching). If the decorative material has two or more plies, the holes are introduced through the entire decorative material, i.e. through all plies of the decorative material.

The holes are preferably introduced into the decorative layer in such a way that the longitudinal axis of each hole is arranged parallel and/or congruent and/or obliquely to a surface normal of the front side of the decorative layer at the exit point of the respective hole. Furthermore, the holes can in particular run parallel to one another.

The holes are preferably designed in such a way that the cross section of the holes is round or elliptical or angular perpendicular to their longitudinal axis. A round cross section is particularly preferred.

Preferably, a carrier is attached to the rear side of the light guide layer or to the rear side of the decorative layer, in particular by molding and/or casting and/or bonding and/or welding. Preferably, the carrier is attached after the application of the light-conductive material to form the light guide layer (above step c)) and before the arrangement of the illumination and/or display unit on or in the shaped part (above step d)). The carrier can be designed as a carrier layer, wherein the carrier layer is completely or partially attached to the rear side of the decorative layer or the rear side of the light guide layer, in particular by molding and/or casting and/or bonding and/or welding. The carrier may comprise or be formed from one or more fastening elements, such as hooks or clips.

The carrier can be formed from a plastics material, for example polyurethane (PUR) and/or polycarbonate (PC) and/or polypropylene (PP). Furthermore, it can be provided that the carrier is injection-molded onto the rear side of the decorative layer. Alternatively, the carrier can be bonded or pressed onto the rear side of the decorative layer, in particular by means of one or more adhesive plies. The carrier can be attached or formed in such a way that it has a recess in a region of the holes for accommodating the illumination and/or display unit.

It can be provided that before the holes of the micro-perforation are introduced, a lamination, for example comprising fleece and adhesive, is arranged on the rear side of the decorative layer, wherein the holes are also introduced into the lamination when the micro-perforation is introduced, so that the holes extend from the front side of the decorative layer through the lamination.

According to one embodiment of the method, it is provided that the transparent or translucent, highly conductive material is molded or cast onto the rear side of the decorative layer, wherein the material completely penetrates into the holes of the micro-perforation during molding or casting, so that the holes are completely filled with the material of the light guide layer, and furthermore the holes are overfilled with the material of the light guide layer in such a way that said material emerges at the front side of the decorative layer and a protruding layer is formed on the front side of the decorative layer, at least in the region of the micro-perforation.

It can be provided that the light guide layer is molded or cast on, whereby the light guide layer assumes its intended shape, i.e., in particular the shape in the finished component, during molding or casting. Alternatively, it can be provided that the light guide layer is reshaped after attachment, in particular together with the decorative layer, in order to form the intended shape. Alternatively, the light guide layer can already have the intended shape before it is attached. In this case, the light guide layer can be attached by bonding and/or pressing it onto the rear side or the front side of the decorative layer.

The light guide layer can be embossed on its front side, in particular by an insert in the manufacturing tool, for example embossed paper.

The invention is explained in more detail below also with regard to further features and advantages on the basis of the description of embodiments and with reference to the accompanying schematic drawings, in which:

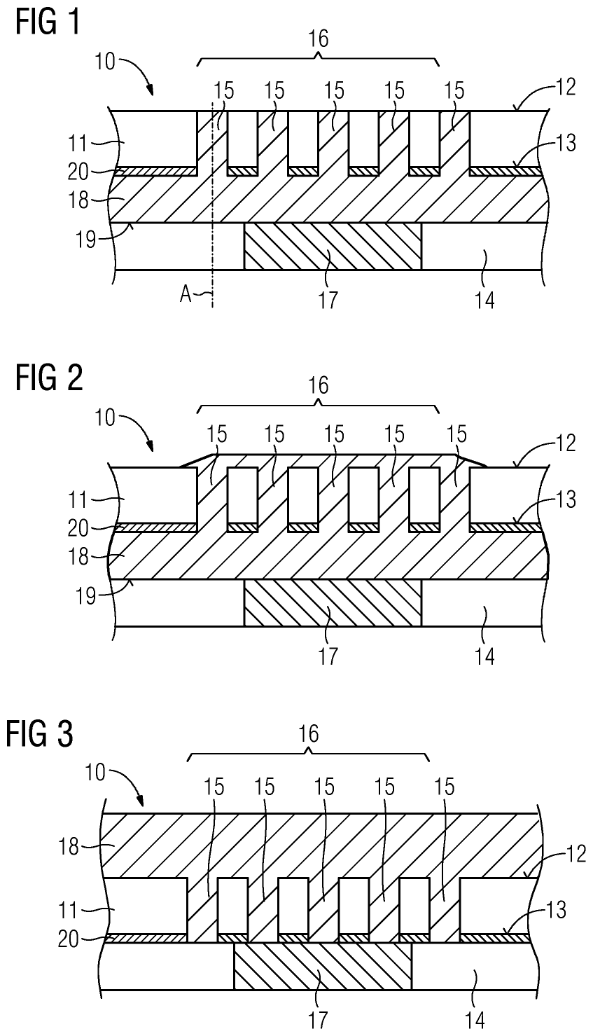

FIG. 1 shows a first embodiment of a shaped part according to the invention in a schematic sectional view,

FIG. 2 shows a second embodiment of a shaped part according to the invention in a schematic sectional view,

FIG. 3 shows a third embodiment of a shaped part according to the invention in a schematic sectional view.

Corresponding parts and components, also across the various embodiments, are identified by the same reference signs in FIGS. 1 to 3.

FIG. 1 to FIG. 3 each show a decorative and/or panel part according to the invention, designed as a shaped part 10, for a vehicle interior. The shaped part 10 comprises a decorative layer 11 made of wood veneer having a front side 12 designed as a visible side, a rear side 13 opposite the front side 12, and a micro-perforation 16 formed by a plurality of through holes 15, wherein the holes 15 each extend in a straight line along their corresponding longitudinal axis A between the rear side 13 and the front side 12 of the decorative layer 11.

The shaped part 10 further comprises a transparent or translucent light guide layer 18, wherein the light guide layer 18 is arranged on the rear side 13 of the decorative layer 11 according to the embodiments shown in FIG. 1 and FIG. 2 and on the front side 12 of the decorative layer 11 according to the embodiment shown in FIG. 3. The light guide layer 18 according to each of the three embodiments extends completely into the holes 15 of the micro-perforation 16, so that the holes 15 are completely filled with the material of the light guide layer 18. Preferably, the light guide layer 18 is made of PUR.

The shaped part 10 also comprises a carrier 14 designed as a carrier layer, wherein the carrier 14 is arranged on the rear side 19 of the light guide layer 18 according to the embodiments shown in FIG. 1 and FIG. 2 and on the rear side 13 of the decorative layer 11 according to the embodiment shown in FIG. 3. The carrier 14 has a recess in the region of the micro-perforation 16. For example, the carrier 14 is a plastic carrier which is injection-molded onto the rear side 13 of the decorative layer 11 or onto the rear side 19 of the light guide layer 18.

A lamination 20 is arranged on the rear side 13 of the decorative layer 11, that is to say according to the embodiments shown in FIG. 1 and FIG. 2 between the rear side 13 of the decorative layer 11 and the light guide layer 18 and according to the embodiment shown in FIG. 3 between the rear side 13 of the decorative layer 11 and the carrier 14. The lamination 20 comprises a fleece which is arranged by means of adhesive on the rear side 13 of the decorative layer 11.

Furthermore, the shaped part 10 comprises an illumination and/or display unit 17, in particular a display. The illumination and/or display unit 17 is arranged in the region of the micro-perforation 16 on or in the carrier 14. FIG. 1 to FIG. 3 show that the illumination and/or display unit 17 is arranged in the recess in the carrier 14. Light emanating from the illumination and/or display unit 17 can be guided through the micro-perforation 16 of the decorative layer 11 to the visible side of the shaped part 10.

FIG. 2 shows that the light guide layer 18 is arranged on the rear side 13 of the decorative layer 11, wherein the light guide layer 18 extends completely into the holes 15 of the micro-perforation 16, and wherein the holes 15 are furthermore overfilled with the material of the light guide layer 18 in such a way that a thin overhang layer made of the material of the light guide layer 18 is formed on the front side 12 of the decorative layer 11 in the region of the micro-perforation 16.

Three embodiments of methods according to the invention for producing the shaped parts 10 according to the invention according to the embodiments shown in FIG. 1 to FIG. 3 will be described below.

First, in all embodiments, according to a step a), a decorative material is provided for forming a decorative layer 11 of the shaped part 10, wherein the decorative layer 11 has a front side 12 designed as a visible side and a rear side 13 opposite the front side 12. Optionally, the decorative layer 11 can then be laminated. The lamination 20 according to the embodiments shown in FIG. 1 to FIG. 3 is formed from fleece and adhesive.

Subsequently, also in all embodiments, according to a step b), a plurality of through holes 15 are introduced into the decorative layer 11 to form a micro-perforation 16 in such a way that the holes 15 each extend in a straight line along their corresponding longitudinal axis A between the rear side 13 and the front side 12 of the decorative layer 11. The holes 15 are also introduced into the lamination 20 when the micro-perforation 16 is introduced, so that the holes 15 extend from the front side 12 of the decorative layer 11 through the lamination 20. The holes 15 are preferably introduced by means of lasers or punching, for example fine punching.

Furthermore, according to a step c), a transparent or translucent, highly conductive material, in particular PUR, is molded or cast onto the decorative layer 11 in order to form a light guide layer 18. To form the shaped parts 10 according to the embodiments shown in FIG. 1 and FIG. 2, the material is molded or cast onto the rear side 13 of the decorative layer 11. To form the shaped part 10 according to the embodiment shown in FIG. 3, the transparent or translucent, highly conductive material is molded or cast onto the front side 12 of the decorative layer 11. When the material is molded or cast on, it completely penetrates the holes 15 of the micro-perforation 16, so that the holes 15 are completely filled with the material of the light guide layer 18.

In order to produce a shaped part 10 according to the embodiment in FIG. 2, the transparent or translucent, highly conductive material is molded or cast onto the rear side 13 of the decorative layer 11. When the material is molded or cast on, it completely penetrates the holes 15 of the micro-perforation 16, so that the holes 15 are completely filled with the material of the light guide layer 18. In addition, the holes 15 are overfilled with the material of the light guide layer 18 in such a way that said material emerges at the front side 12 of the decorative layer 11 and a thin overhang layer made of the material of the light guide layer 18 is formed on the front side 12 of the decorative layer 11 in the region of the micro-perforation 16.

Subsequently, a carrier 14 is attached to the rear side 19 of the light guide layer 18 in the case of the embodiments shown in FIG. 1 and FIG. 2 and to the rear side 13 of the decorative layer 11 in the case of the embodiment shown in FIG. 3. The carrier 14 can be designed, for example, as a carrier layer which is injection-molded or cast on. Alternatively, the carrier 14 can also be prefabricated and bonded or welded on. The carrier layer can be provided completely or partially on the rear side 13 of the decorative layer 11 or the rear side 19 of the light guide layer 18.

Subsequently, according to a step d), an illumination and/or display unit 17 is arranged on or in the shaped part 10, wherein light emanating from the illumination and/or display unit 17 can be guided through the micro-perforation 16 of the decorative layer 11 to the visible side of the shaped part 10. For this purpose, the illumination and/or display unit 17 is arranged in the region of the micro-perforation on the rear side 13 of the decorative layer 11.

### LIST OF REFERENCE SIGNS

10 Shaped part
11 Decorative layer
12 Front side
13 Rear side
14 Carrier
15 Holes
16 Micro-perforation
17 Illumination and/or display unit
18 Light guide layer
19 Rear side
20 Lamination
A Longitudinal axis

1. A shaped part, comprising
a decorative layer having a front side designed as a visible side and a rear side opposite the front side,
a micro-perforation formed by a plurality of through holes, where-in the holes each extend in a straight line along their corresponding longitudinal axis between the rear side and the front side of the decorative layer,
an illumination and/or display unit, wherein light emanating from the illumination and/or display unit can be guided through the micro-perforation of the decorative layer to the visible side of the shaped part,
a transparent or translucent light guide layer, wherein the light guide layer is arranged on the front side or on the rear side of the decora-tive layer, wherein the light guide layer extends at least partially into the holes of the micro-perforation, so that the holes are at least partially filled with the material of the light guide layer.

2. The shaped part according to claim 1,
characterized in that
the light guide layer comprises PUR or is formed from PUR, or
the light guide layer comprises or is formed from a clear plastics ma-terial, in particular PMMA or PC.

3. The shaped part according to either claim 1,
characterized in that
the shaped part comprises a carrier, wherein the carrier is ar-ranged on the rear side of the light guide layer or on the rear side of the decorative layer.

4. The shaped part according to claim 3,
characterized in that
the carrier is a carrier layer, wherein the carrier layer is arranged completely or partially on the rear side of the decorative layer or the rear side of the light guide layer.

5. The shaped part according to claim 1,
characterized in that
the carrier comprises or is formed from one or more fastening ele-ments.

6. The shaped part according to claim 1,
characterized in that
a lamination is arranged on the rear side of the decorative layer.

7. The shaped part according to claim 1,
characterized in that
the light guide layer is arranged on the rear side of the decorative layer, wherein the light guide layer extends completely into the holes of the micro-perforation, wherein the holes are overfilled with the material of the light guide layer in such a way that an overhang layer made of the material of the light guide layer is formed on the front side of the decorative layer, at least in the region of the micro-perforation.

8. A method for producing a shaped part, wherein the method comprises the steps of:
a) providing a decorative material for forming a decorative layer of the shaped part, wherein the decorative layer has a front side designed as a visible side and a rear side opposite the front side,
b) introducing a plurality of through holes into the decorative layer to form a micro-perforation in such a way that the holes each ex-tend in a straight line along their corresponding longitudinal axis between the rear side and the front side of the decorative layer,
c) applying, in particular by molding or casting, a transparent or translu-cent, highly conductive material to the front side or to the rear side of the decorative layer to form a light guide layer, wherein the material for forming the light guide layer penetrates at least partially into the holes of the micro-perforation, so that the holes are at least partially filled with the material of the light guide layer,
d) arranging at least one illumination and/or display unit on or in the shaped part, wherein light emanating from the illumination and/or display unit can be guided through the micro-perforation of the decorative layer to the visible side of the shaped part.

9. The method according to claim 8,
characterized in that
the material for forming the light guide layer comprises PUR or is formed from PUR, or
the material for forming the light guide layer comprises or is formed from a clear plastics material, in particular PMMA or PC.

10. The method according to either claim 8,
characterized in that
a carrier is attached to the rear side of the light guide layer or to the rear side of the decorative layer.

11. The method according to claim 10,
characterized in that
the carrier is designed as a carrier layer, wherein the carrier layer is completely or partially attached to the rear side of the decorative layer or the rear side of the light guide layer.

12. The method according to claim 10,
characterized in that
the carrier comprises or is formed from one or more fastening ele-ments.

13. The method according to claim 8,
characterized in that
before the holes of the micro-perforation are introduced, a lami-nation is arranged on the rear side of the decorative layer, wherein the holes are also introduced into the lamination when the micro-perforation is introduced, so that the holes extend from the front side of the decorative layer through the lamination.

14. The method according to claim 8,
characterized in that
the transparent or translucent, highly conductive material is molded or cast onto the rear side of the decorative layer, wherein the material completely penetrates into the holes of the micro-perforation during molding or casting, so that the holes are completely filled with the material of the light guide layer, and furthermore the holes are overfilled with the material of the light guide layer in such a way that said material emerges at the front side of the decorative layer and an overhang layer is formed on the front side of the decorative layer, at least in the region of the micro-perforation.

15. The method according to claim 8,
characterized in that
the light guide layer is molded or cast on, wherein the light guide lay-er assumes its intended shape during molding or casting, or
the light guide layer is deformed after application to form the intended shape, or
the light guide layer already has the intended shape before attach-ment, wherein the light guide layer is attached by bonding and/or pressing onto the rear side or the front side of the decorative layer.
